(19) United States
(12) Patent Application Publication
(10) Pub. No.: US 2013/0105105 A1
(43) Pub. Date: May 2, 2013

(54) BIMETALLIC SEAL FOR AIR HEATERS

(71) Applicant: Harlod L. O'Brien, Columbus, OH (US)

(72) Inventor: Harlod L. O'Brien, Columbus, OH (US)

(21) Appl. No.: 13/612,832

(22) Filed: Sep. 13, 2012

Related U.S. Application Data
(60) Provisional application No. 61/553,805, filed on Oct. 31, 2011.

(51) Int. Cl. F16J 15/16; F28D 19/04

(52) U.S. Cl. 165/9; 277/360

(57) ABSTRACT

A bimetallic seal for an air heater is designed to flex and close a gap as the temperature changes. The laminated metal/bimetallic seal is designed such that when subjected to a temperature change, the laminated metals deflect and this deflection is used provide a seal to control leakage. With its ability to deflect with a temperature change, the laminated metal proves to be a material that can deflect to accommodate the clearances caused by the structural deformation found in air heaters. Various mounting configurations can be used, depending on the conditions in each air heater. The bimetallic seal can be used in air handlers and other devices that are exposed to a temperature change.

### CROSS-REFERENCE TO RELATED APPLICATION

This application claims the benefit of priority of U.S. provisional application number U.S. 61/553,805, filed Oct. 31, 2011, the contents of which are herein incorporated by reference.

### BACKGROUND OF THE INVENTION

The present invention relates to seals and, more particularly, to a bimetallic seal for air heaters that adjusts with changes in temperature.

An air heater is a device for the transfer of heat from a waste heat stream to an incoming air stream using a heat transfer surface in a rotor which moves through the gas and air streams.

A major components is the rotor which is divided into pie shaped sectors by diaphragms which extend from the shaft to the outside diameter of the air heater. There are typically 12 to 24 sectors in an air heater which are each filled with a heat transfer medium. Rotors are typically 7 to 65 feet in diameter and the rotor/heat transfer surface can be more than 6 feet thick. The rotor assembly rotates within the housing and is positioned within the housing by a support bearing and a guide bearing. The housing provides the connection to the gas and air ducts.

Air heater leakage is inherent in all air-to-gas heat exchangers in varying degrees. The driving force that causes leakage is the difference in static pressure levels between the air and gas streams. The rotor of an air heater undergoes structural deformation due to the temperature difference between the hot and cold ends of the rotor. This deformation affects the seal clearance in the various sealing locations. Air heaters typically contain radial seals, circumferential seals, axial seals, and post seals. The effects of thermal gradients on air heater structural deformation is seen in four main distortions—rotor down turn, axial expansion, radial sealing plate distortion, and oval distortion and rotor chording.

All of these distortions come into play when attempting to minimize leakage. Various systems have been designed to take advantage of or compensate for these distortions.

Air heater leakage is proportional to the square root of the pressure differential and is dependent on fluid density. The primary benefit of reduced leakage is a reduction in fluid that is moved by the forced draft and induced draft fans. A reduction of leakage eliminates power required to move fluid that adds nothing to the cycle. Thus, a seal that reduces leakage can add to the efficiency of the cycle and reduce the cost of operation.

As can be seen, there is a need for a seal that can react to deformations and provide an improved seal to reduce leakage, improve efficiency and reduce the cost of operation of air heaters.

### SUMMARY OF THE INVENTION

In one aspect of the present invention, a seal comprises a bimetallic material configured to bend between a cold position and a hot position, the bend configured reduce leakage as operating conditions of a machine change.

In another aspect of the present invention, a seal disposed to seal against a sector plate of an air heater comprises a bimetallic material configured to bend between a cold position and a hot position, the bend configured reduce leakage as temperature of the air heater changes.

These and other features, aspects and advantages of the present invention will become better understood with reference to the following drawings, description and claims.

### BRIEF DESCRIPTION OF THE DRAWINGS

FIG. 1 is a partially cut away perspective view of an air heater according to an exemplary embodiment of the present invention;

FIG. 2 is a cross-sectional view of a bimetallic seal having a top edge bent to stiffen its upper edge and folded back over to form a sector plate sealing edge according to an exemplary embodiment of the present invention;

FIG. 3 is a cross-sectional view of a bimetallic seal having an angle iron stiffener according to another exemplary embodiment of the present invention;

FIG. 4 is a cross-sectional view of a bimetallic seal having an angle iron stiffener and wear strip to contact the sector plate according to another exemplary embodiment of the present invention;

FIG. 5 is a cross-sectional view of a bimetallic seal designed as a two-part seal in a cold configuration according to another exemplary embodiment of the present invention;

FIG. 6 is a cross-sectional view of the bimetallic seal of FIG. 5, designed as a two-part seal in a hot configuration; and

FIG. 7 is a cross-sectional view of a bimetallic seal fabricated in a bowed cold setting that straightens out when warmed, including a preset stop set to stop the seal at the desired location, according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a bimetallic seal for an air heater that is designed to flex and close a gap as the temperature changes. The laminated metal/bimetallic seal is designed such that when subjected to a temperature change, the laminated metals deflect and this deflection is used provide a seal to control leakage. With its ability to deflect with a temperature change, the laminated metal proves to be a material that can deflect to accommodate the clearances caused by the structural deformation found in air heaters. Various mounting configurations can be used, depending on the conditions in each air heater and in which location the bimetallic seal is being installed. The bimetallic seal can also be used in air handlers and other devices that are exposed to a temperature change.

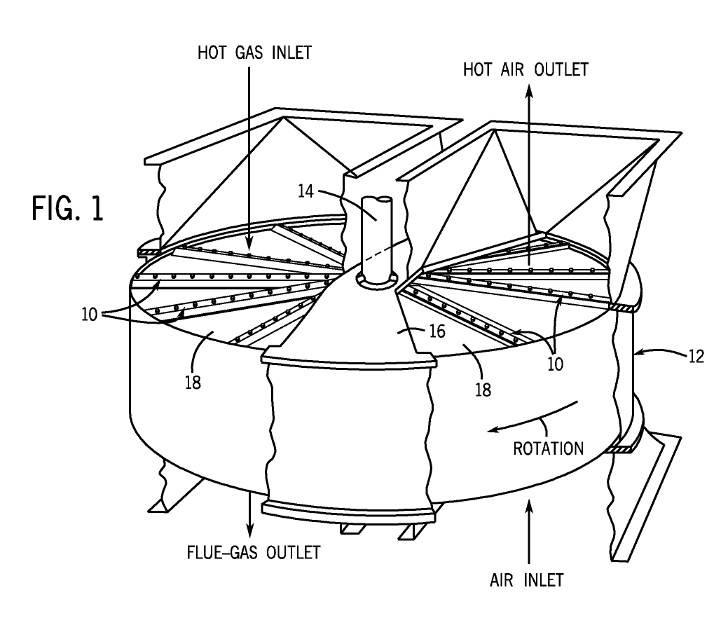

Referring to FIG. 1, an air heater 12 is shown having a rotational shaft 14 designed to rotate diaphragms 18 of the heater 12. Sector plates 16 can be disposed on the heater 12 as is known in the art. A plurality of bimetallic seals 10 can be used in the heater 12, as described in greater detail below. As the air heater 12 flexes when going from ambient temperature to operating temperature, the bimetallic seals 12 flex in the opposite direction and close up the gap to reduce leakage.

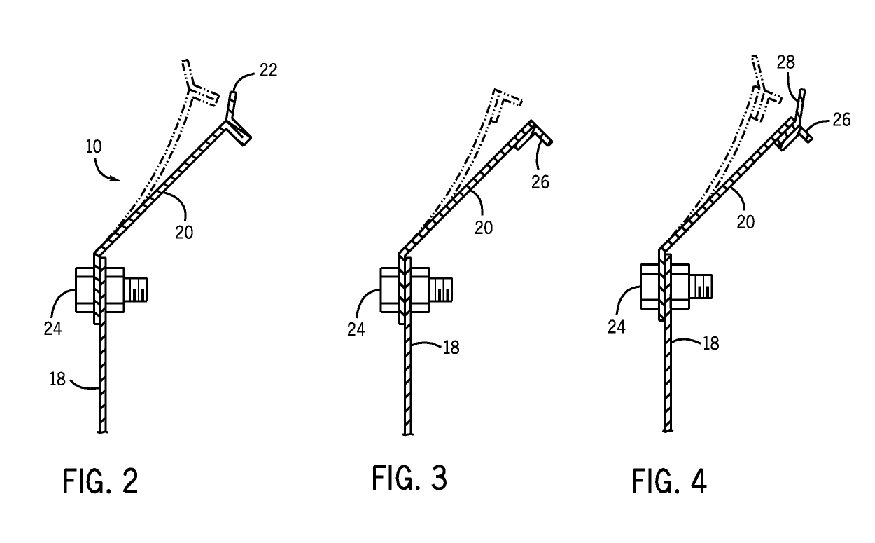

Referring to FIG. 2, a bimetallic member 20 can attach to the diaphragm 18 of the air heater 12 with a fastening bolt 24. A cold position is shown with solid lines and a hot position is shown with dotted lines in FIG. 2. The bimetallic member 20 can be bent to stiffen the upper edge and folded back over to form a sector plate sealing edge 22.

Referring to FIG. 3, the bimetallic member 20 can be stiffened with an angle iron stiffener 26 disposed on an outside edge of the bimetallic member 20. A cold position is shown with solid lines and a hot position is shown with dotted lines in FIG. 3.

Referring now to FIG. 4, the bimetallic member 20 can be stiffened with the angle iron stiffener 26, similar to the embodiment described in FIG. 3, but can further include a Teflon® or metal wear strip 28. The wear strip can be designed to contact the sector plate 16 of the air heater 12. A cold position is shown with solid lines and a hot position is shown with dotted lines in FIG. 4.

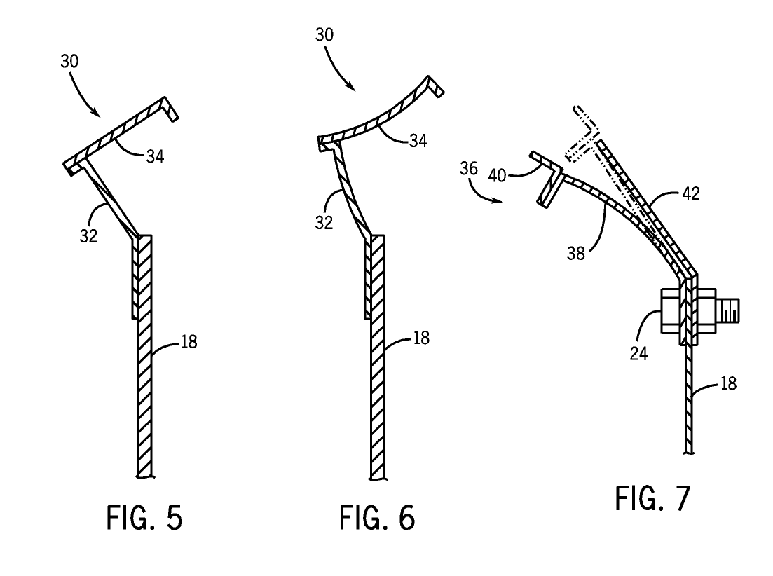

Referring to FIGS. 5 and 6, a bimetallic seal 30 can include a first bimetallic member 32 attached to the diaphragm 18 of the air heater 12, extending at a first angle from the diaphragm 18. A second bimetallic member 34 can extend from the first bimetallic member 32 at a second angle thereto. The first and second bimetallic member s can be positioned so that they can advantageous bend from a cold position (FIG. 5) to a hot position (FIG. 6) to create an improved seal. In one embodiment, as shown in FIGS. 5 and 6, the bimetallic members 32, 34 can be disposed to bow in opposite directions when heated.

Referring now to FIG. 7, a bimetallic seal 36 can include a bimetallic material 38 configured to be bent in a cold position, as shown by the solid line of FIG. 7. When the bimetallic material 38 is heated, it can straighten as shown by the dotted line in FIG. 7. A stiffener 40 can optionally be added to the end of the bimetallic material 38 as shown. When straightened while heated, the seal 36 goes against a stop 42 that determines vertical height. When the seal 36 goes against the stop, it begins to develop spring force to resist the pressure differential across the seal 36. The stop 42 can be provided prevent seal movement when the pressure differential tries to move the seal higher. The stop 42 and the bimetallic material 38 can be attached to the diaphragm 18 of the air heater 12 by, for example, the fastening member 24.

Existing seals are set with the air heater in the cold position and in some locations open up as the air heater flexes. This permits leakage across the incoming and outgoing air/gas passages. The bimetallic seals of the present invention reduces leakage to improve air heater performance and reduce power usage.

It should be understood, of course, that the foregoing relates to exemplary embodiments of the invention and that modifications may be made without departing from the spirit and scope of the invention as set forth in the following claims.

What is claimed is:

1. A seal comprising:
a bimetallic material configured to bend between a cold position and a hot position, the bend configured reduce leakage as operating conditions of a machine change.

2. The seal of claim 1, wherein the machine is an air heater and the seal is attached to diaphragms of the air heater to seal against a sector plate of the air heater.

3. The seal of claim 2, further comprising a fastening bolt connecting the bimetallic material to the diaphragms.

4. The seal of claim 1, further comprising a stiffening mechanism at an end of the bimetallic material.

5. The seal of claim 4, further comprising a bent sealing edge.

6. The seal of claim 4, further comprising an angle iron stiffener attached to the end of the bimetallic material.

7. The seal of claim 6, further comprising a wear strip attached to the end of the bimetallic material.

8. The seal of claim 1, further comprising a first bimetallic material configured to bow in a first direction when heated and a second bimetallic material configured to bow in a second, opposite direction when heated.

9. The seal of claim 1, wherein the bimetallic material is bowed in a cold condition and straightens in a hot condition.

10. The seal of claim 9, further comprising a stop limiting the movement of the bimetallic material in the hot condition.

11. A seal disposed to seal against a sector plate of an air heater, the seal comprising:
a bimetallic material configured to bend between a cold position and a hot position, the bend configured reduce leakage as temperature of the air heater changes.
